(19) United States
(12) Patent Application Publication
(10) Pub. No.: US 2026/0239397 A1
(43) Pub. Date: Aug. 13, 2026

(54) WIRELESS TRANSMITTING DEVICE, WIRELESS RECEIVING DEVICE, AND METHOD OF OPERATING THE WIRELESS RECEIVING DEVICE

(71) Applicant: SAMSUNG ELECTRONICS CO., LTD., Suwon-si (KR)

(72) Inventors: Wondeuk YOON, Suwon-si (KR); Sangho LEE, Suwon-si (KR)

(73) Assignee: SAMSUNG ELECTRONICS CO., LTD., Suwon-si (KR)

(21) Appl. No.: 19/411,949

(22) Filed: Dec. 8, 2025

(30) Foreign Application Priority Data
Feb. 12, 2025 (KR) 10-2025-0017991

(51) Int. Cl. H04W 72/30; G06F 3/16; H04W 72/1263

(52) U.S. Cl. CPC H04W 72/30; G06F 3/165; H04W 72/1263

(57) ABSTRACT

Disclosed is a wireless transmitting device which includes a signal generator and a communication interface. The signal generator generates a first signal and a second signal. The first signal is a signal for distance estimation by an external electronic device. The second signal a plurality of audio sources and mapping information, the mapping information mapping a plurality of transmission areas to the plurality of audio sources. The communication interface transmits the first signal and the second signal to a wireless receiving device.

### CROSS-REFERENCE TO RELATED APPLICATIONS

This application claims priority under 35 U.S.C. § 119 to Korean Patent Application No. 10-2025-0017991 filed on February 12, 2025, in the Korean Intellectual Property Office, the disclosure of which is incorporated by reference herein in its entirety.

### BACKGROUND

Embodiments of the present disclosure described herein relate to a semiconductor device, and more particularly, relate to a wireless transmitting device, a wireless receiving device, and a method of operating the wireless receiving device.

With the recent development of technologies, Bluetooth communication technology is widely used in industrial sites, performance sites, etc. In industrial sites, data may be exchanged using a smartphone, a tablet, an earphone, etc., conveniently and without the complicated wiring using Bluetooth communication technology. Thus, Bluetooth communication technology may contribute to an increase in work efficiency. In performance sites, data may be exchanged by using a wireless microphone, a speaker, a light, etc., and thus, the Bluetooth communication technology may enable more convenient and free performance production. In particular, in audience participation-type performances, the audience’s smart devices may be connected through Bluetooth to communicate in real time and to induce participation. As such, the Bluetooth communication is utilized in various manners in the industrial sites and the performance sites, and the Bluetooth communication technology is expected to be used in more fields.

### SUMMARY

Embodiments of the present disclosure provide a wireless transmitting device and a wireless receiving device capable of improving the level of safety of workers in an industrial site and improving the immersion level of an audience in a performance site.

Embodiments of the present disclosure provide a method of operating the wireless transmitting device and the wireless receiving device.

Embodiments of the present disclosure provide a wireless communication system including the wireless transmitting device and the wireless receiving device.

According to an embodiment, a wireless transmitting device includes a signal generator and a communication interface. The signal generator generates a first signal and a second signal. The first signal is a signal for distance estimation by an external electronic device. The second signal includes a plurality of audio sources and mapping information, the mapping information mapping a plurality of transmission areas to the plurality of audio sources. The communication interface transmits the first signal and the second signal to a wireless receiving device. .

According to an embodiment, a wireless receiving device includes a communication interface and an audio source selection and playback circuit. The communication interface is configured to receive a first signal for distance estimation by an external electronic device from a wireless transmitting device, and receive a second signal including a plurality of audio sources and mapping information, the mapping information comprising mapping between a plurality of transmission areas and the plurality of audio sources from the wireless transmitting device. The audio source selection and playback circuit is configured to: based on the first signal and the second signal, estimate a distance to the wireless transmitting device, select one of the plurality of audio sources, and play back the selected audio source.

According to an embodiment, in a method of operating a wireless receiving device, a first signal and a second signal are received. The first signal is a signal for distance estimation by an external electronic device, the second signal comprises mapping information and a plurality of audio sources, the mapping information comprising mapping between a plurality of transmission areas and the plurality of audio sources. The method may also include estimating a distance to a wireless transmitting device based on the first signal; selecting one of the plurality of audio sources based on the second signal and the estimated distance to the wireless transmitting device; and playing the selected audio source.

### BRIEF DESCRIPTION OF DRAWINGS

The above and other objects and features of the present disclosure will become apparent by describing in detail embodiments thereof with reference to the accompanying drawings.

FIG. 1 is a block diagram illustrating a wireless communication system according to an embodiment of the present disclosure.

FIG. 2 is a diagram illustrating exemplary transmission areas of FIG. 1.

FIG. 3 is a diagram illustrating an embodiment of mapping information of FIG. 1.

FIG. 4 is a block diagram illustrating an embodiment of a wireless transmitting device of FIG. 1.

FIG. 5 is a flowchart illustrating an exemplary method performed by a wireless transmitting device of FIG. 4.

FIG. 6 is a diagram illustrating a second signal of FIG. 5.

FIG. 7 is a block diagram illustrating an embodiment of a wireless receiving device of FIG. 1.

FIG. 8 is a flowchart illustrating an exemplary method performed by a wireless receiving device of FIG. 7.

FIG. 9 is a flowchart illustrating an embodiment of a process in which a wireless receiving device of FIG. 8 selects one of a plurality of audio sources based on mapping information and distance to a wireless transmitting device according to estimation.

FIG. 10 is a block diagram illustrating a wireless communication system according to an embodiment of the present disclosure.

FIGS. 11A and 11B are exemplary diagrams illustrating pieces of mapping information of FIG. 10.

FIG. 12 is a flowchart illustrating an exemplary method performed by a wireless receiving device of FIG. 10.

FIG. 13 is a block diagram illustrating a wireless communication system according to an embodiment of the present disclosure.

FIG. 14 is a block diagram illustrating a wireless communication system according to an embodiment of the present disclosure.

### DETAILED DESCRIPTION

Below, embodiments of the present disclosure will be described in detail and clearly to such an extent that one skilled in the art easily carries out the present disclosure.

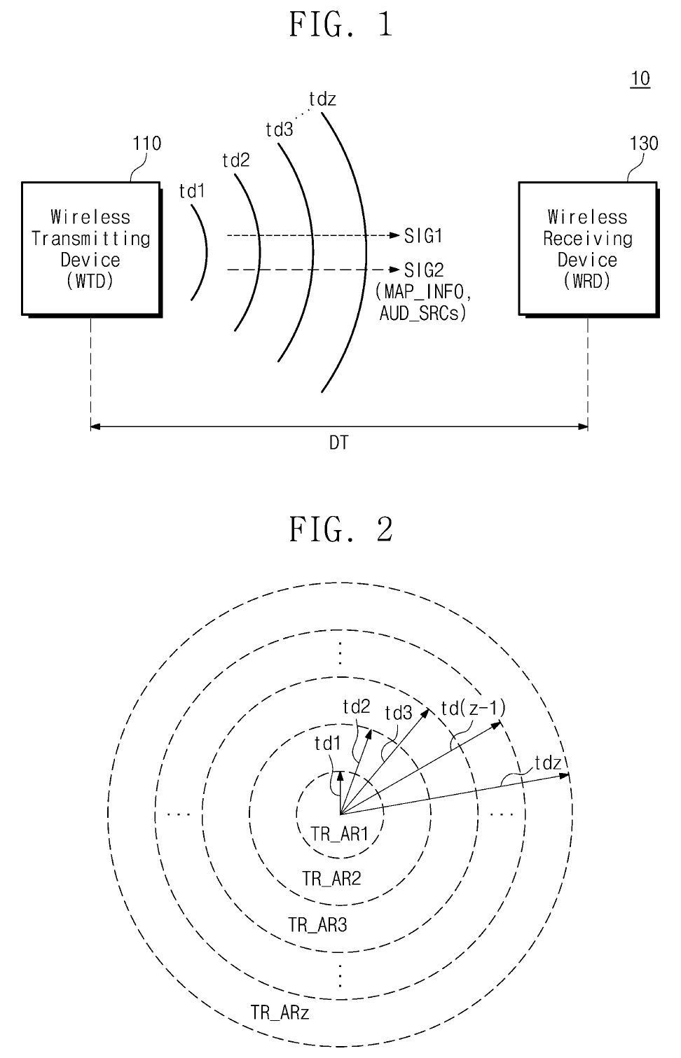

FIG. 1 is a block diagram illustrating a wireless communication system according to an embodiment of the present disclosure.

Referring to FIG. 1, a wireless communication system 10 may include a wireless transmitting device (WTD) 110 and a wireless receiving device (WRD) 130.

In an embodiment, the wireless transmitting device 110 and the wireless receiving device 130 may be Bluetooth low energy (LE) devices which communicate based on a channel sounding technology or a Bluetooth^{®} LE audio auracast technology. The Bluetooth channel sounding technology may include a technology for measuring a distance between two devices with high accuracy by analyzing various physical phenomena (e.g., reflection, refraction, and attenuation) which radio waves experience while passing through a specific channel. The Bluetooth^{®} LE audio auracast technology may be based on wireless communication between Bluetooth LE devices and may include a technology for transmitting audio sources with high quality and a low power to broadcast from one Bluetooth LE device to multiple other Bluetooth LE devices. For example, the wireless transmitting device 110 and the wireless receiving device 130 may be a smartphone, a tablet PC, an Internet of Things (IoT) device, an Internet of Everything (IoE) device, an e-book, a virtual reality (VR) device, an augmented reality (AR) device, a drone, a smart device, an automotive device, or various wearable devices such as a smart watch, an earphone/headset, smart glasses, a smart ring, and a hands-free.

The wireless transmitting device 110 may transmit a first signal SIG1 and a second signal SIG2.

In an embodiment, the first signal SIG1 may be based on the Bluetooth channel sounding technology, and the second signal SIG2 may be based on the Bluetooth^{®} LE audio auracast technology.

In an embodiment, the first signal SIG1 may be a signal for distance estimation by an external electronic device, and the second signal SIG2 may be a signal for transmission of mapping information and audio sources.

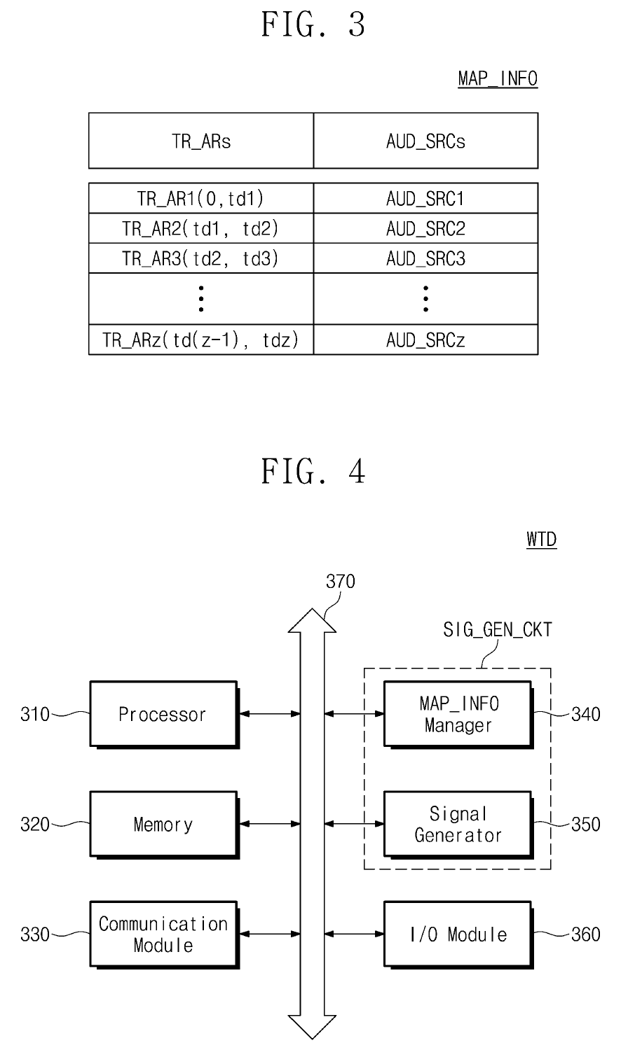

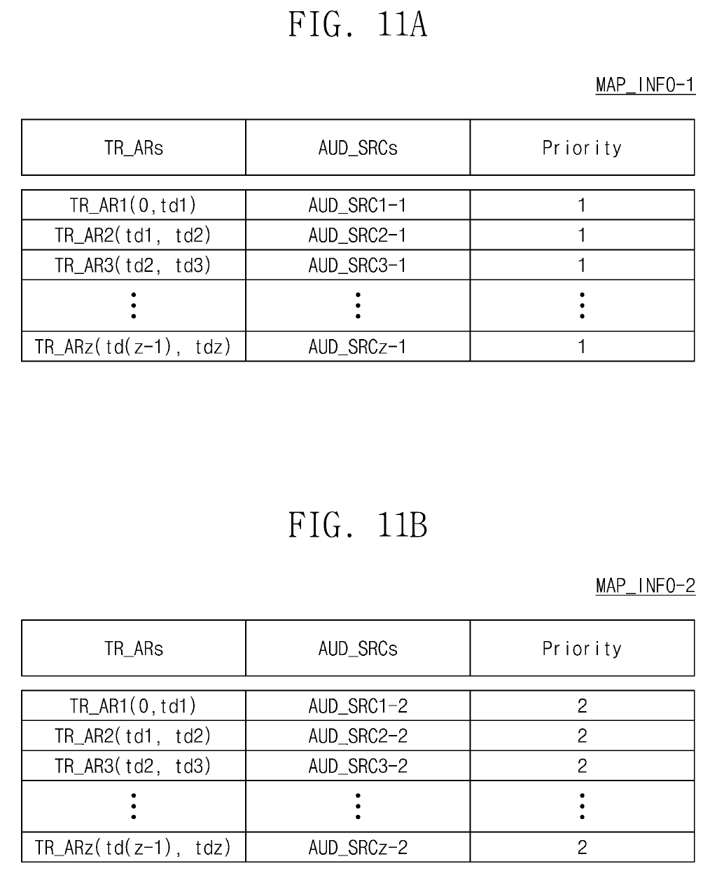

The second signal SIG2 may include mapping information MAP_INFO and a plurality of audio sources AUD_SRCs. In an embodiment, the mapping information MAP_INFO may indicate relationships between transmission distances and the plurality of audio sources AUD_SRCs. The transmission distance may be, for example, a distance which is expanded in a radial type from the wireless transmitting device 110. In the embodiment illustrated in FIG. 1, the transmission distances may be expressed by td1, td2, td3, ..., tdz (z being an integer of 4 or more as shown in the example in FIG. 1), and a plurality of transmission areas may be the transmission distances of the plurality of audio sources from the wireless transmitting device 110. The mapping information will be described with reference to FIGS. 3, 11A, and 11B. The transmission areas will be described with reference to FIG. 2.

In an embodiment, the first signal SIG1 and the second signal SIG2 may be periodically broadcast, but the scope of the present disclosure is not limited thereto.

Based on the first signal SIG1 and the second signal SIG2, the wireless receiving device 130 may estimate a distance to the wireless transmitting device 110, may select one of the plurality of audio sources AUD_SRCs. In embodiments, the wireless receiving device 130 may play back the selected audio source.

In an embodiment, the wireless receiving device 130 may scan the broadcasting by the wireless transmitting device 110 and may receive the first signal SIG1 and the second signal SIG2.

In an embodiment, the wireless receiving device 130 may estimate a distance between the wireless receiving device 130 and the wireless transmitting device 110 based on the first signal SIG1. The wireless receiving device 130 may select one of the plurality of audio sources AUD_SRCs based on the distance to the wireless transmitting device 110 according to the estimation and the mapping information MAP_INFO included in the second signal SIG2. The distance to the wireless transmitting device 110 may be a straight distance from the wireless receiving device 130 to the wireless transmitting device 110, but is not limited thereto.

In an embodiment, the wireless receiving device 130 may store information on all or some of the plurality of audio sources AUD_SRCs. The audio sources thus stored may be utilized according to various purposes and/or may be erased after the utilization is completed. The audio sources may be the ones received from the wireless transmitting device 110 during the operation of the wireless receiving device 130, and not audio sources stored in the wireless receiving device 130 from the power-on timing of the wireless receiving device 130.

In an embodiment, the wireless transmitting device 110 and the wireless receiving device 130 may be variously utilized in an industrial site or a performance site. For example, in the industrial site, the wireless transmitting device 110 may be attached to a dangerous object (e.g., a type of vehicle used in construction, road paving, etc., such as bulldozers, excavators, etc.) or may be possessed by a worker of the dangerous object. In embodiments, the wireless receiving device 130 may be attached to an article which another worker possesses or mounts. The combination of the wireless transmitting device 110 and the wireless receiving device 130 may be used to improve safety by having the wireless receiving device 130 output an audio source (e.g., alarm) to let worker/operator of the dangerous object (attached to the wireless transmitting device 110) and/or the another worker (attached to wireless receiving device 130) know that they are dangerously close to each other and to move away or exercise caution when the wireless receiving device 130 is within a certain distance of the wireless transmitting device 110. It must be understood that the specification is not limited to the above example.

As another example, in a performance site (e.g., concert venues, etc.), the wireless transmitting device 110 may be attached to an instrument, a mixer/audio interface, an amplifier, etc., and the wireless receiving device 130 may be possessed or mounted by an audience member which watches a performance. The combination of the wireless transmitting device 110 and the wireless receiving device 130 may be used to improve audience experience by having the wireless receiving device 130 possessed or mounted by an audience member output an audio source (e.g., specific instrument, speaker, etc.) to the audience member of the audience based on the position of the audience member relative to the various audio sources and the wireless transmitting device 110. Thus, an optimum experience may be curated for the audience member. It must be understood that the specification is not limited to the above example.

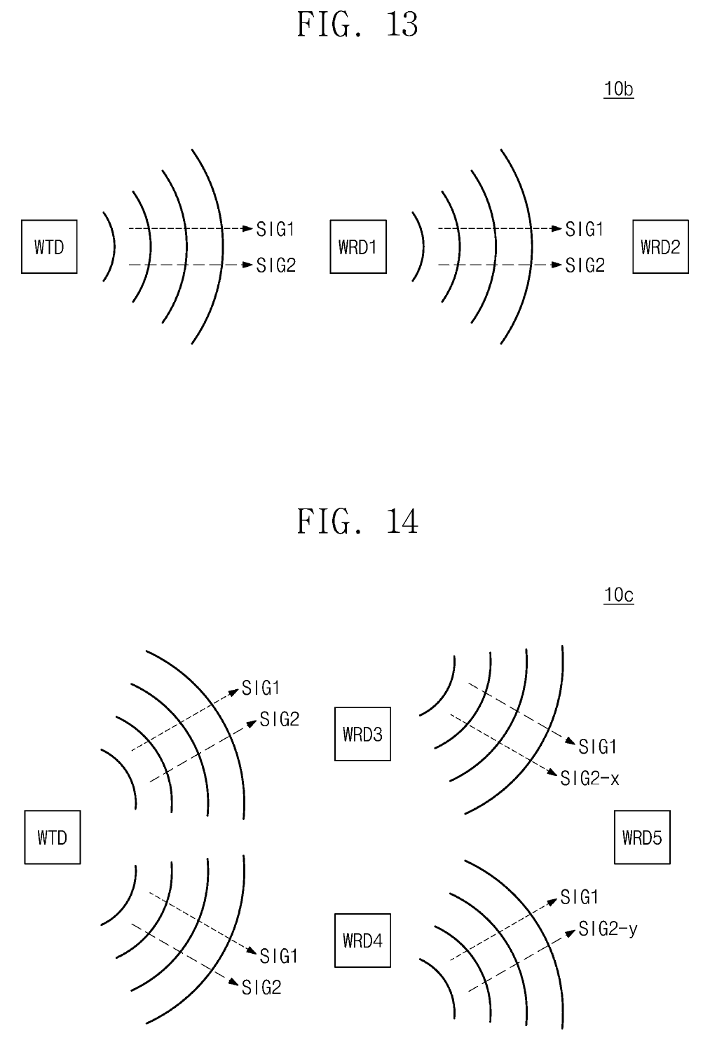

In FIG. 1, for convenience of description, one wireless transmitting device 110 and one wireless receiving device 130 are illustrated, but a plurality of wireless transmitting devices and a plurality of wireless receiving devices may be provided, which will be described with reference to FIG. 13 or 14.

Through the above configuration, in a wireless communication system according to embodiments of the present disclosure, a wireless transmitting device may transmit a first signal for distance estimation and a second signal for transmission or selection of audio sources to a wireless receiving device. The second signal may include mapping information and a plurality of audio sources; based on the first signal and the second signal, the wireless receiving device may estimate a distance to the wireless transmitting device, may select an audio source to be played back by the wireless receiving device from among the plurality of audio sources, and may play back the selected audio source. The audio source to be played back by the wireless receiving device may change depending on the distance to the wireless transmitting device, may include a warning signal in the industrial site, and may include performance music in the performance site. Accordingly, it may be possible to improve the level of safety of workers in the industrial site and to improve the immersion level of an audience in the performance site.

FIG. 2 is a diagram for describing a plurality of transmission areas of FIG. 1.

A plurality of transmission areas TR_AR1, TR_AR2, TR_AR3, ..., TR_ARz are illustrated in FIG. 2.

Referring to FIGS. 1 and 2, the plurality of transmission areas TR_AR1 to TR_ARz may be in the shape of a concentric circle and may be based on the transmission distances (e.g., td1 to tdz) described with reference to FIG. 1, and the wireless transmitting device 110 may be located at the center of the concentric circle. For example, the transmission area TR_AR1 may be in the shape of a circle in which the transmission distance is smaller than or equal to td1, the transmission area TR_AR2 may be in the shape of a circle in which the transmission distance is greater than td1 and is smaller than or equal to td2, and the transmission area TR_AR3 may be in the shape of a circle in which the transmission distance is greater than td2 and is smaller than or equal to td3. The transmission area TR_ARz may be in the shape of a circle in which the transmission distance is greater than td(z-1) and is smaller than or equal to tdz.

FIG. 3 is a diagram for describing an embodiment of mapping information of FIG. 1.

Referring to FIGS. 1 and 3, the mapping information MAP_INFO may be included in the second signal SIG2 together with the plurality of audio sources AUD_SRCs. The MAP_INFO may indicate relationships between the plurality of transmission areas TR_ARs and the plurality of audio sources AUD_SRCs.

In an embodiment, the plurality of transmission areas TR_ARs may respectively correspond to the plurality of transmission areas TR_AR1 to TR_Arz described with reference to FIG. 2 and may respectively correspond to the plurality of audio sources AUD_SRCs.

For example, the transmission area TR_AR1 may correspond to the audio source AUD_SRC1, the transmission area TR_AR2 may correspond to the audio source AUD_SRC2, and the transmission area TR_AR3 may correspond to the audio source AUD_SRC3. The transmission area TR_ARz may correspond to the audio source AUD_SRCz.

For example, the mapping information MAP_INFO may map the transmission area TR_AR1 to the audio source AUD_SRC1, may map the transmission area TR_AR2 to the audio source AUD_SRC2, and may map the transmission area TR_AR3 to the audio source AUD_SRC3. The mapping information MAP_INFO may map the transmission area TR_ARz to the audio source AUD_SRCz.

In an embodiment, the plurality of audio sources AUD_SRCs may be different types of audio sources or may be audio sources of differing intensities, but the disclosure is not limited thereto. For example, the audio sources AUD_SRC1 to AUD_SRCz may be warning signals. The audio source AUD_SRC1 may be a warning signal which warns more strongly than the audio source AUD_SRC2, the audio source AUD_SRC2 may be a warning signal which warns more strongly than the audio source AUD_SRC3. In some embodiments, the audio source AUD_SRC(z-1) may be a warning signal which warns more strongly than the audio source AUD_SRCz. However, the scope of the present disclosure is not limited thereto. In another embodiment, the plurality of audio sources AUD_SRCs may be audio sources with the same type or may be audio sources with different volumes. For example, the level of the volume of the audio source AUD_SRC1 may be higher than the level of the volume of the audio source AUD_SRC2, the level of the volume of the audio source AUD_SRC2 may be higher than the level of the volume of the audio source AUD_SRC3. In some embodiments, the level of the volume of the audio source AUD_SRC(z-1) may be higher than the level of the volume of the audio source AUD_SRCz. However, the scope of the present disclosure is not limited thereto.

FIG. 4 is a block diagram illustrating an embodiment of a wireless transmitting device of FIG. 1.

In FIG. 4, a wireless transmitting device WTD may correspond to the wireless transmitting device 110 of FIG. 1.

Referring to FIGS. 1 and 4, the wireless transmitting device WTD may include a processor 310, a memory 320, a communication module 330, a mapping information (MAP_INFO) manager 340, a signal generator 350, an input/output module 360, and a bus 370.

The processor 310 may control all the components 320, 330, 340, 350, 360, and 370 of the wireless transmitting device WTD.

The memory 320 may store the mapping information MAP_INFO or the plurality of audio sources AUD_SRCs input through the input/output module 360. The input/output module 360 may include any one or any combination of a socket, a plug, a cable, a universal serial bus (USB), a keyboard, a scanner, a digital modem, a radio frequency (RF) modem, an antenna circuit, a WiFi chip, and their equivalents along with related software and/or firmware

The mapping information manager 340 may manage or update the mapping information MAP_INFO. In an embodiment, the mapping information manager 340 may map two or more transmission areas to one audio source rather than mapping the plurality of transmission areas TR_ARs to the plurality of audio sources AUD_SRCs, respectively. That is, the mapping information manager 340 may map a plurality of transmission areas to one audio source or the mapping information manager 340 may map a plurality of audio sources to a transmission area of the plurality of transmission areas. In embodiments of the latter scenario, the plurality of audio sources mapped to a transmission area may be of different types or may have different purposes. In an embodiment, the mapping information manager 340 may add, delete, or change a plurality of entries which are included in the mapping information MAP_INFO and each of which includes one or more transmission areas and one audio source.

The signal generator 350 may generate the first signal SIG1 and the second signal SIG2. In an embodiment, the first signal SIG1 may be a signal for distance estimation by an external electronic device, and the second signal SIG2 may include the mapping information MAP_INFO and the plurality of audio sources AUD_SRCs.

The communication module 330 may include any one or any combination of a digital modem, a radio frequency (RF) modem, an antenna circuit, a WiFi chip, and related software and/or firmware.. The communication module 330 may transmit the first signal SIG1 and the second signal SIG2. For example, the communication module 330 may periodically broadcast the first signal SIG1 and the second signal SIG2.

The bus 370 may perform communication between the components 310, 320, 330, 340, 350, and 360 of the wireless transmitting device WTD.

In an embodiment, the mapping information manager 340 and the signal generator 350 may be collectively referred to a “signal generation circuit SIG_GEN_CKT” The signal generation circuit SIG_GEN_CKT may perform key operations for generating the first signal SIG1 and the second signal SIG2 in the wireless transmitting device according to embodiments of the present disclosure.

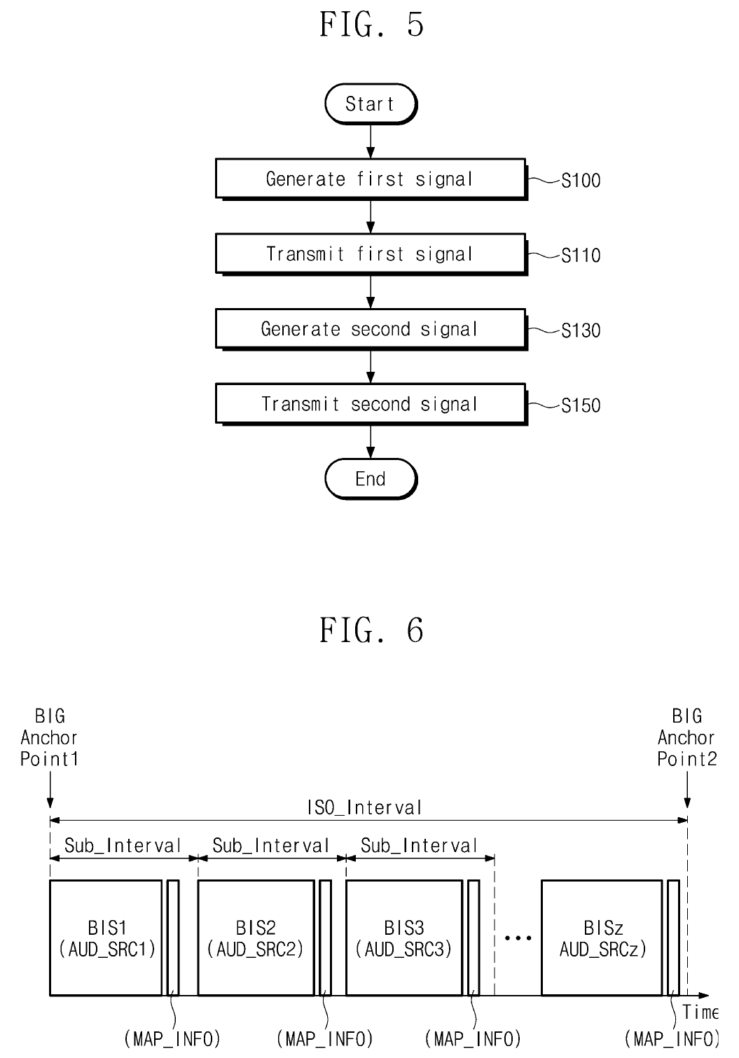

FIG. 5 is a flowchart illustrating an embodiment of operations which a wireless transmitting device of FIG. 4 performs.

Referring to FIGS. 1, 4, and 5, the wireless transmitting device WTD (e.g., wireless transmitting device 110) may generate the first signal SIG1 (S100).

In an embodiment, the first signal SIG1 may be based on the Bluetooth channel sounding technology.

The wireless transmitting device WTD may transmit the first signal SIG1 (S110).

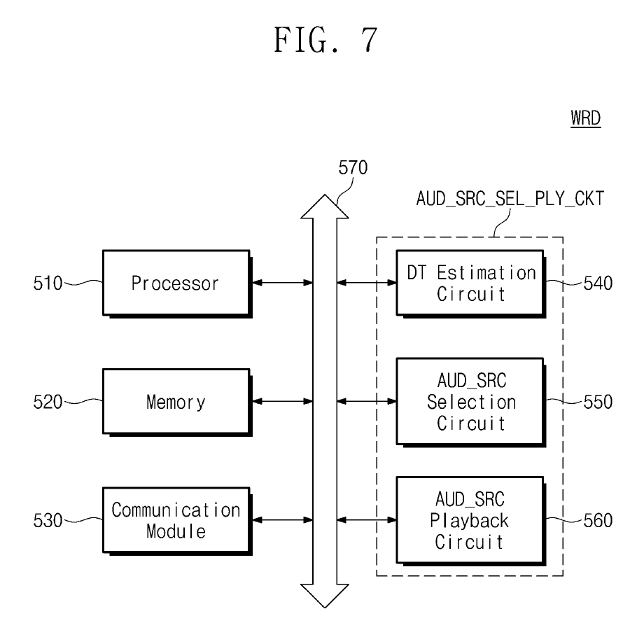

In an embodiment, the wireless transmitting device WTD may be an “initiator” of the Bluetooth LE device, and a wireless receiving device WRD (e.g., wireless receiving device 130) (refer to FIG. 7) may be a “reflector” of the Bluetooth LE device. However, the scope of the present disclosure is not limited thereto.

The wireless transmitting device WTD may generate the second signal SIG2 (S130).

In an embodiment, the second signal SIG2 may be based on the Bluetooth^{®} LE audio auracast technology. For example, the second signal SIG2 may be a broadcast isochronous group (BIG) according to the Bluetooth LE technology.

The wireless transmitting device WTD may transmit the second signal SIG2 (S150).

In an embodiment, the wireless transmitting device WTD may periodically transmit the first signal SIG1 and the second signal SIG2.

FIG. 6 is a diagram for describing a second signal of FIG. 5.

Referring to FIGS. 1, 5, and 6, the second signal SIG2 may be the BIG and may include a plurality of Broadcast Isochronous Streams (BISs) and the mapping information MAP_INFO.

In an embodiment, the second signal SIG2 may include a first BIS BIS1, a second BIS BIS2, a third BIS BIS3, ..., a z-th BIS BISz and the mapping information MAP_INFO. The first to z-th BISs – e.g., BIS1 to BISz – may be sequentially transmitted from BIG anchor point 1, and the first to z-th BISs – e.g., BIS1 to BISz – may again be sequentially transmitted from next BIG anchor point 2.

In an embodiment, the mapping information MAP_INFO may be transmitted between any BIS and a next BIS. For example, the mapping information MAP_INFO may be transmitted after one BIS (e.g., BIS1) is transmitted and before a next BIS (e.g., BIS2) is transmitted. Accordingly, in the embodiment illustrated in FIG. 6, the mapping information may be repeatedly transmitted as much as the number of BISs transmitted between BIG anchor point 1 and BIG anchor point 2. However, the scope of the present disclosure is not limited thereto. In another embodiment, the mapping information MAP_INFO may be transmitted only once between BIG anchor point 1 and BIG anchor point 2. Accordingly, the second signal SIG2 may include one or more mapping information MAP_INFO between BIG anchor point 1 and BIG anchor point 2.

In an embodiment, the first to z-th BISs – e.g., BIS1 to BISz – may include the plurality of audio sources AUD_SRC1, AUD_SRC2, AUD_SRC3, ..., AUD_SRCz, respectively. For example, the first BIS BIS1 may include the audio source AUD_SRC1, the second BIS BIS2 may include the audio source AUD_SRC2, and the third BIS BIS3 may include the audio source AUD_SRC3, so on and so forth. The z-th BIS BISz may be the audio source AUD_SRCz.

In an embodiment, a time interval between one BIG anchor point and a next BIG anchor point may include “ISO_Interval”, and a time interval between a start point of one BIG and a start point of a next BIG may be “Sub_Interval”. For example, the mapping information may be transmitted once or more within the ISO_Interval, and the audio source may be transmitted within each time interval Sub_Interval. The mapping information and the audio source included in each BIS may be received, for example, by detecting or storing, by the wireless receiving device WRD, the BIS received within each time interval Sub_Interval belonging to the ISO_Interval based on the BIG anchor point.

FIG. 7 is a block diagram illustrating an embodiment of a wireless receiving device of FIG. 1.

In FIG. 7, the wireless receiving device WRD may correspond to the wireless receiving device 130 of FIG. 1.

Referring to FIGS. 1 and 7, the wireless receiving device WRD may include a processor 510, a memory 520, a communication module 530, a distance (DT) estimation circuit 540, an audio source (AUD_SRC) selection circuit 550, an audio source playback circuit 560, and a bus 570.

The processor 510 may control all the components 520, 530, 540, 550, 560, and 570 of the wireless receiving device WRD.

The memory 520 may store all or some of the plurality of audio sources AUD_SRCs and the mapping information MAP_INFO included in the second signal SIG2 received through the communication module 530.

The communication module 530 may receive the first signal SIG1 and the second signal SIG2.

The distance estimation circuit 540 may estimate a distance from the wireless receiving device WRD to the wireless transmitting device WTD based on the first signal SIG1.

The audio source selection circuit 550 may select one of the plurality of audio sources AUD_SRCs based on the mapping information MAP_INFO and the distance to the wireless transmitting device WTD according to the estimation.

The audio source playback circuit 560 may play back the selected audio source.

In an embodiment, the distance estimation circuit 540, the audio source selection circuit 550, and the audio source playback circuit 560 may be collectively referred to as an “audio source selection and playback circuit AUD_SRC_SEL_PLY_CKT”. The audio source selection and playback circuit AUD_SRC_SEL_PLY_CKT may perform key operations for playing back the selected audio source in the wireless receiving device WRD according to embodiments of the present disclosure.

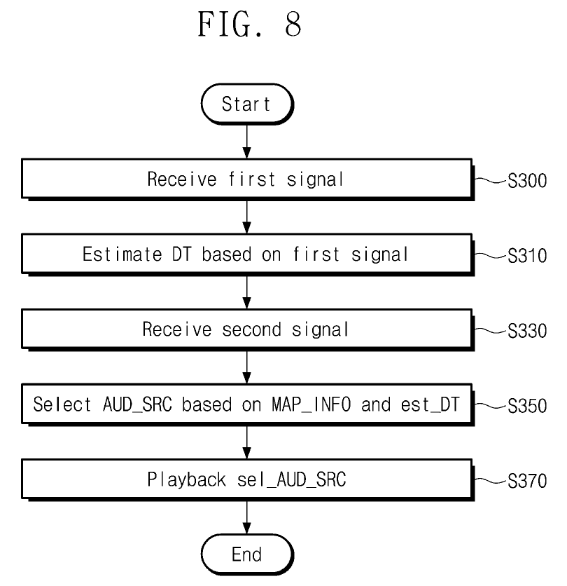

FIG. 8 is a flowchart illustrating an embodiment of operations which a wireless receiving device of FIG. 7 performs.

Referring to FIGS. 1, 7, and 8, the wireless receiving device WRD (e.g., wireless receiving device 130) may receive the first signal SIG1 (S300).

In an embodiment, the first signal SIG1 may be based on the Bluetooth channel sounding technology.

The wireless receiving device WRD may estimate a distance DT from the wireless receiving device WRD to the wireless transmitting device WTD based on the first signal SIG1 (S310).

In an embodiment, the wireless transmitting device WTD may be an “initiator” of the Bluetooth LE device, and the wireless receiving device WRD may be a “reflector” of the Bluetooth LE device. However, the scope of the present disclosure is not limited thereto.

The wireless receiving device WRD may receive the second signal SIG2 (S330).

The wireless receiving device WRD may select one of the plurality of audio sources AUD_SRCs based on the mapping information MAP_INFO and a distance est_DT to the wireless transmitting device WTD according to the estimation (S350).

In an embodiment, the wireless receiving device WRD may search the mapping information MAP_INFO for a transmission area corresponding to the distance est_DT to the wireless transmitting device WTD according to the estimation and may select an audio source corresponding to the found transmission area. However, the scope of the present disclosure is not limited thereto.

The wireless receiving device WRD may play back a selected audio source sel_AUD_SRC (S370).

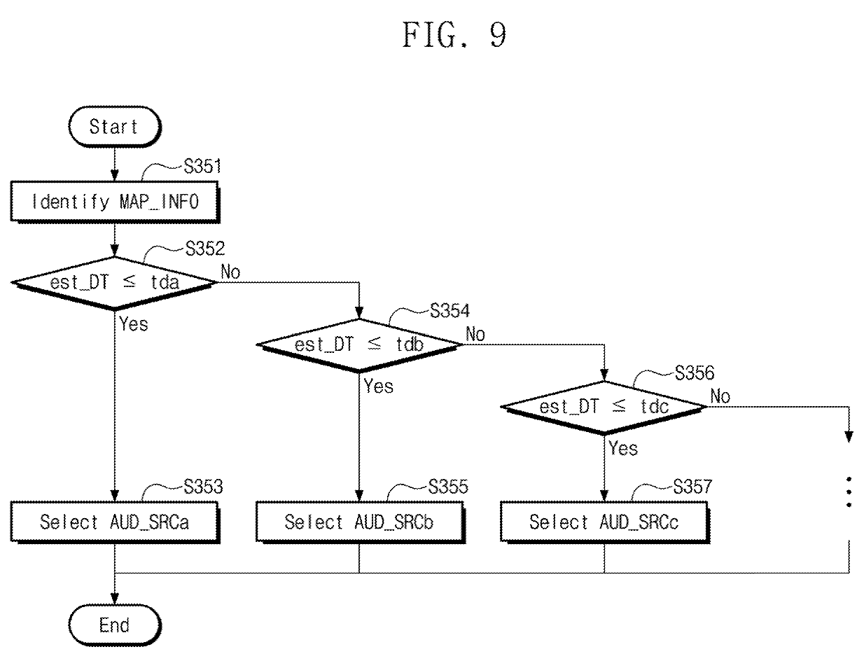

FIG. 9 is a flowchart illustrating an embodiment of an operation in which a wireless receiving device of FIG. 8 selects one of a plurality of audio sources based on mapping information and a distance to a wireless transmitting device according to estimation.

Referring to FIGS. 8 and 9, in operation S350 in which one of a plurality of audio sources is selected, the wireless receiving device WRD may identify the mapping information MAP_INFO (S351).

In an embodiment, the mapping information MAP_INFO may correspond to the mapping information MAP_INFO illustrated in FIG. 3.

The wireless receiving device WRD may search the mapping information MAP_INFO and may determine whether the distance est_DT is smaller than or equal to “tda” (S352).

When the distance est_DT is smaller than or equal to “tda” (Yes in operation S352), the wireless receiving device WRD may select an audio source AUD_SRCa (S353).

When the distance est_DT is greater than “tda” (No in operation S352), the wireless receiving device WRD may search the mapping information MAP_INFO and may determine whether the distance est_DT is smaller than or equal to “tdb” (S354).

When the distance est_DT is smaller than or equal to “tdb” (Yes in operation S354), the wireless receiving device WRD may select an audio source AUD_SRCb (S355).

When the distance est_DT is greater than “tdb” (No in operation S354), the wireless receiving device WRD may search the mapping information MAP_INFO and may determine whether the distance est_DT is smaller than or equal to “tdc” (S356).

When the distance est_DT is smaller than or equal to “tdc” (Yes in operation S356), the wireless receiving device WRD may select an audio source AUD_SRCc (S357).

In an embodiment, tda, tdb, and tdc described in operation S352, operation S354, and operation S356 may be td1, td2, and td3 in the mapping information MAP_INFO of FIG. 3. For example, in operation S352, operation S354, and operation S356, the wireless receiving device WRD may compare the distance est_DT with a distance by which one transmission area is distinguished from another transmission area, by referring to the mapping information MAP_INFO. In this case, whether the wireless receiving device WRD is placed in any transmission area among a plurality of transmission areas may be determined according to operation S352, operation S354, and operation S356.

In an embodiment, when the distance est_DT is greater than “tdc” (No in operation S356), the wireless receiving device WRD may search the mapping information MAP_INFO, and thus, whether the wireless receiving device WRD is placed in any transmission area may be continuously determined.

In an embodiment, as described with reference to FIG. 3, the plurality of audio sources AUD_SRC1 to AUD_SRCz may be different types of audio sources or may be audio sources with the same type and different volumes. For example, as a distance from the wireless receiving device WRD to the wireless transmitting device WTD decreases (or as the wireless receiving device WRD is placed in a transmission area closer to the wireless transmitting device WTD from among the transmission areas), an audio source which is selected by the wireless receiving device WRD and is played back in the wireless receiving device WRD may be a warning signal warning more strongly or may have a higher volume.

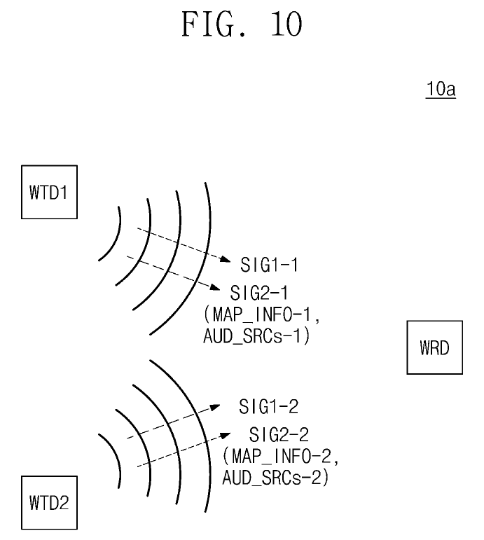

FIG. 10 is a block diagram illustrating a wireless communication system according to an embodiment of the present disclosure.

Referring to FIG. 10, a wireless communication system 10a may include a plurality of wireless transmitting devices WTD1 and WTD2 and the wireless receiving device WRD.

In an embodiment, each of the plurality of wireless transmitting devices WTD1 and WTD2 may correspond to the wireless transmitting device WTD described with reference to FIGS. 1 and 4, and the wireless receiving device WRD may correspond to the wireless receiving device WRD described with reference to FIGS. 1 and 7.

The wireless transmitting device WTD1 may transmit a first signal SIG1-1 and a second signal SIG2-1, and the wireless transmitting device WTD2 may transmit a first signal SIG1-2 and a second signal SIG2-2.

In an embodiment, the second signal SIG2-1 may include mapping information MAP_INFO-1 and a plurality of audio sources AUD_SRCs-1, and the second signal SIG2-2 may include mapping information MAP_INFO-2 and a plurality of audio sources AUD_SRCs-2.

In an embodiment, the mapping information MAP_INFO-1 may indicate relationships between distances from the wireless transmitting device WTD1 and the plurality of audio sources AUD_SRCs-1. Herein, the transmission distance may include, for example, a distance which is expanded in a radial type from the wireless transmitting device WTD1. The mapping information MAP_INFO-2 may indicate relationships between distances from the wireless transmitting device WTD2 and the plurality of audio sources AUD_SRCs-2. Herein, the transmission distance may include, for example, a distance which is expanded in a radial type from the wireless transmitting device WTD2.

Based on the first signal SIG1-1 and the second signal SIG2-1, the wireless receiving device WRD may estimate the distance to the wireless transmitting device WTD1, may select one of the plurality of audio sources AUD_SRCs-1, and may play back the selected audio source. Based on the first signal SIG1-2 and the second signal SIG2-2, the wireless receiving device WRD may estimate a distance to the wireless transmitting device WTD2, may select one of the plurality of audio sources AUD_SRCs-2, and may play back the selected audio source. In this case, the selected audio source among the plurality of audio sources AUD_SRCs-1 and the selected audio source among the plurality of audio sources AUD_SRCs-2 may be simultaneously played back in the wireless receiving device WRD, but the present disclosure is not limited thereto. In another embodiment, the selected audio source among the plurality of audio sources AUD_SRCs-1 and the selected audio source among the plurality of audio sources AUD_SRCs-2 may contend for playback in the wireless receiving device WRD.

In an embodiment, the wireless receiving device WRD may store only the selected audio source among the plurality of audio sources AUD_SRCs-1, may store only the selected audio source among the plurality of audio sources AUD_SRCs-2, or may store both the selected audio source among the plurality of audio sources AUD_SRCs-1 and the selected audio source among the plurality of audio sources AUD_SRCs-2.

In an embodiment, the wireless receiving device WRD may select an audio source to be played back in the wireless receiving device WRD, based on the mapping information MAP_INFO-1, the mapping information MAP_INFO-2, the distance to the wireless transmitting device WTD1 according to the estimation, and the distance to the wireless transmitting device WTD2 according to the estimation. For example, if the distance to the wireless transmitting device WTD1 is greater than the distance to the wireless transmitting device WTD2, then the wireless receiving device WRD may play the selected audio source among the plurality of audio sources AUD_SRCs-2 before the selected audio source among the plurality of audio sources AUD_SRCs-1. It may also be vice versa. As an example, in the context of the construction site example presented herein, if the worker attached to the wireless receiving device 130 is closer to a first dangerous machine/worker of the first dangerous machine that a first wireless transmitting device 110 is attached to than a second dangerous machine/worker of the second dangerous machine that a second wireless transmitting device 110 is attached to, the wireless receiving device 130 may select an audio source associated with the first transmitting device 110 to warn the worker attached to the wireless receiving device 130.

For convenience of description, only two wireless transmitting devices WTD1 and WTD2 are illustrated in FIG. 10, but the number of wireless transmitting devices is provided only as an example.

FIGS. 11A and 11B are diagrams for describing pieces of mapping information of FIG. 10.

The mapping information MAP_INFO-1 of FIG. 10 is illustrated in FIG. 11A, the mapping information MAP_INFO-2 of FIG. 10 is illustrated in FIG. 11B, and each of the mapping information MAP_INFO1 and MAP-INFO-2 may further include a priority compared to the mapping information MAP_INFO of FIG. 3.

Referring to FIG. 11A, the second signal SIG2-1 transmitted from the wireless transmitting device WTD1 may include the mapping information MAP_INFO-1; in the mapping information MAP_INFO-1, the priority of each of the plurality of audio sources AUD_SRCs may be set to “1”.

Referring to FIG. 11B, the second signal SIG2-2 transmitted from the wireless transmitting device WTD2 may include the mapping information MAP_INFO-2; in the mapping information MAP_INFO-2, the priority of each of the plurality of audio sources AUD_SRCs may be set to “2”.

Referring to FIGS. 10, 11A, and 11B, the wireless receiving device WRD may select an audio source to be played back in the wireless receiving device WRD, based on the priorities of the second signals SIG2-1 and SIG2-2 respectively received from the wireless transmitting device WTD1 and the wireless transmitting device WTD2. For example, because the priority (e.g., “1”) set in the mapping information MAP_INFO-1 is higher than the priority (e.g., “2”) set in the mapping information MAP_INFO-2, even though the selected audio source among the plurality of audio sources AUD_SRCs-1 and the selected audio source among the plurality of audio sources AUD_SRCs-2 contend for playback in the wireless receiving device WRD, the selected audio source among the plurality of audio sources AUD_SRCs-1 may be played back in the wireless receiving device WRD.

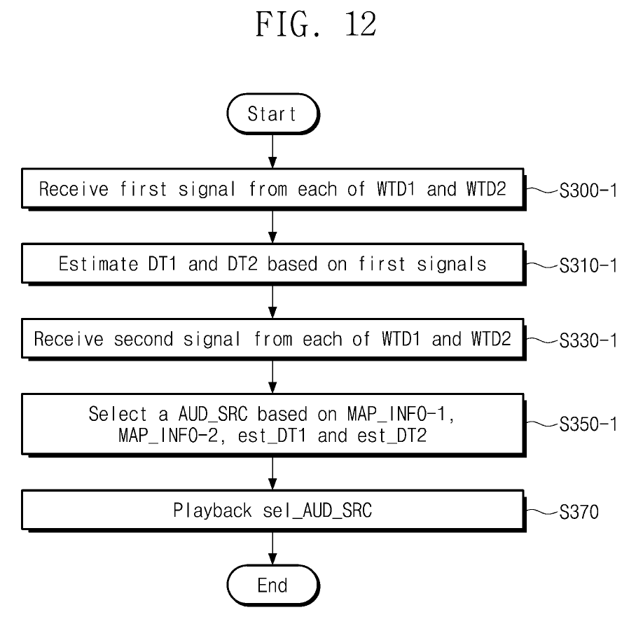

FIG. 12 is a flowchart illustrating an embodiment of operations which a wireless receiving device of FIG. 10 performs.

Referring to FIGS. 10 and 12, the wireless receiving device WRD may receive the first signals SIG1-1 and SIG1-2 from the wireless transmitting devices WTD1 and WTD2, respectively (S300-1).

Distances DT1 and DT2 from the wireless receiving device WRD to the wireless transmitting devices WTD1 and WTD2 may be estimated based on the first signals SIG1-1 and SIG1-2 (S310-1).

The wireless receiving device WRD may receive the second signals SIG2-1 and SIG2-2 from the wireless transmitting devices WTD1 and WTD2, respectively (S330-1).

The wireless receiving device WRD may select an audio source to be played back in the wireless receiving device WRD from among the plurality of audio sources AUD_SRCs-1 and AUD_SRCs-2, based on the mapping information MAP_INFO-1, the mapping information MAP_INFO-2, and estimated distances est_DT1 and est_DT2 to the wireless transmitting devices WTD1 and WTD2 (S350-1).

The wireless receiving device WRD may play back the selected audio source sel_AUD_SRC (S370).

FIG. 13 is a block diagram illustrating a wireless communication system according to an embodiment of the present disclosure.

Referring to FIG. 13, a wireless communication system 10b may include the wireless transmitting device WTD and a plurality of wireless receiving devices WRD1 and WRD2.

In an embodiment, the wireless transmitting device WTD may correspond to the wireless transmitting device WTD described with reference to FIGS. 1 and 4, and each of the wireless receiving devices WRD1 and WRD2 may correspond to the wireless receiving device WRD described with reference to FIGS. 1 and 7.

The wireless transmitting device WTD may transmit the first signal SIG1 and the second signal SIG2.

In an embodiment, the second signal SIG2 may include mapping information and a plurality of audio sources.

Based on the first signal SIG1 and the second signal SIG2, the wireless receiving device WRD1 may estimate a distance to the wireless transmitting device WTD, may select one of the plurality of audio sources, and may play back the selected audio source.

In an embodiment, the wireless transmitting device WRD1 may again transmit at least one of the first signal SIG1 and the second signal SIG2. For example, the wireless receiving device WRD1 may transmit the first signal SIG1 and the second signal SIG2 received from the wireless transmitting device WTD without modification. For example, the wireless receiving device WRD1 may store all of the plurality of audio sources and may again transmit the stored audio sources to the wireless receiving device WRD2. In this case, the wireless receiving device WRD1 may further include the signal generation circuit SIG_GEN_CKT illustrated in FIG. 4 in addition to the components 510 to 570 illustrated in FIG. 7, but the scope of the present disclosure is not limited thereto.

Based on the first signal SIG1 and the second signal SIG2, the wireless receiving device WRD2 may estimate a distance to the wireless receiving device WRD1, may select one of the plurality of audio sources, and may play back the selected audio source.

Accordingly, in the wireless communication system 10b of FIG. 13, the transmission area of the wireless transmitting device WTD may be expanded; the wireless communication system 10b may be configured such that the audio source is played back even in the wireless receiving device WRD2 as well as the wireless receiving device WRD1.

FIG. 14 is a block diagram illustrating a wireless communication system according to an embodiment of the present disclosure.

Referring of the FIG. 14, a wireless communication system 10c may include the wireless transmitting device WTD and a plurality of wireless receiving devices WRD3, WRD4, and WRD5.

In an embodiment, the wireless transmitting device WTD may correspond to the wireless transmitting device WTD described with reference to FIGS. 1 and 4, and each of the wireless receiving devices WRD3, WRD4, and WRD5 may correspond to the wireless receiving device WRD described with reference to FIGS. 1 and 7.

The wireless transmitting device WTD may transmit the first signal SIG1 and the second signal SIG2.

In an embodiment, the second signal SIG2 may include mapping information and a plurality of audio sources.

Based on the first signal SIG1 and the second signal SIG2, the wireless receiving device WRD3 may estimate a distance to the wireless transmitting device WTD, may select one of the plurality of audio sources, and may play back the selected audio source.

Based on the first signal SIG1 and the second signal SIG2, the wireless receiving device WRD4 may estimate a distance to the wireless transmitting device WTD, may select one of the plurality of audio sources, and may play back the selected audio source.

In an embodiment, the wireless receiving device WRD3 may again transmit the first signal SIG1 and may again transmit a portion (e.g., a first portion) SIG2-x of the second signal SIG2. Also, the wireless receiving device WRD4 may again transmit the first signal SIG1 and may again transmit the remaining portion (e.g., a second portion) SIG2-y of the second signal SIG2. For example, the first portion SIG2-x of the second signal SIG2 may include some of the plurality of audio sources, and the second portion SIG2-y of the second signal SIG2 may include the others of the plurality of audio sources. For example, the wireless receiving device WRD3 may store the first portion SIG2-x and may again transmit the stored audio sources to the wireless receiving device WRD5. For example, the wireless receiving device WRD4 may store the second portion SIG2-y and may again transmit the stored audio sources to the wireless receiving device WRD5. In this case, each of the wireless receiving device WRD3 and the wireless receiving device WRD4 may further include the signal generation circuit SIG_GEN_CKT illustrated in FIG. 4 in addition to the components 510 to 570 illustrated in FIG. 8, but the scope of the present disclosure is not limited thereto.

Accordingly, in the wireless communication system 10c of FIG. 14, the transmission area of the wireless transmitting device WTD may be expanded, the plurality of audio sources may be transferred to the wireless receiving device WRD5, for example, through multi-path routing, and the wireless communication system 10c be configured such that the audio source is played back even in the wireless receiving device WRD5 as well as the wireless receiving devices WRD3 and WRD4.

In an embodiment, this disclosure includes a system for providing early alarm playback. The system may include a wireless transmitting device; and a wireless receiving device. The wireless transmitting device is configured to: generate a first signal for distance estimation by the wireless receiving device; generate a second signal including comprising a plurality of audio sources and mapping information, the mapping information mapping indicating relationships between a plurality of transmission areas and to the plurality of audio sources; and transmit the first signal and the second signal to the wireless receiving device. The wireless receiving device is configured to: receive the first signal and the second signal from the wireless transmitting device; estimating a distance to a wireless transmitting device based on the first signal; selecting one of the plurality of audio sources based on the second signal and the estimated distance to the wireless transmitting device; and playing back the selected audio source as an early warning.

As described above, in wireless communication system according to embodiments of the present disclosure, a wireless transmitting device may transmit a first signal for distance estimation and a second signal for transmission or selection of audio sources to a wireless receiving device. The second signal may include mapping information and a plurality of audio sources; based on the first signal and the second signal, the wireless receiving device may estimate a distance to the wireless transmitting device, may select an audio source to be played back by the wireless receiving device from among the plurality of audio sources, and may play back the selected audio source. The audio source to be played back by the wireless receiving device may change depending on the distance to the wireless transmitting device, may include a warning signal in the industrial site, and may include performance music in the performance site. Accordingly, it may be possible to improve the level of safety of workers in the industrial site and to improve the immersion level of an audience in the performance site.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A wireless transmitting device comprising:
a signal generator configured to:
generate a first signal for distance estimation by an external electronic device, and
generate a second signal comprising a plurality of audio sources and mapping information, the mapping information mapping a plurality of transmission areas to the plurality of audio sources; and
a communication interface configured to transmit the first signal and the second signal to a wireless receiving device.

2. The wireless transmitting device of claim 1, wherein the mapping information indicates the plurality of audio sources respectively corresponding to the plurality of transmission areas in which the wireless transmitting device is centered.

3. The wireless transmitting device of claim 2, wherein the plurality of transmission areas comprise a first transmission area and a second transmission area,
wherein the plurality of audio sources comprise a first audio source and a second audio source, and
wherein the mapping information comprises mapping of the first transmission area to the first audio source and comprises mapping of the second transmission area to the second audio source.

4. The wireless transmitting device of claim 3, wherein a first distance of the first transmission area from the wireless transmitting device is less than a second distance of the second transmission area from the wireless transmitting device, and
wherein a first volume level of the first audio source is greater than a second volume level of the second audio source.

5. The wireless transmitting device of claim 2, wherein the plurality of transmission areas are circular.

6. The wireless transmitting device of claim 1, wherein the second signal is a broadcast isochronous group (BIG) according to a Bluetooth LE technology and comprises a plurality of broadcast isochronous streams (BISs),
wherein the plurality of BISs respectively comprise the plurality of audio sources, and
wherein the second signal comprises one or more mapping information.

7. The wireless transmitting device of claim 1, wherein the first signal is based on a Bluetooth channel sounding technology, and
wherein the second signal is based on a Bluetooth^{®} LE audio auracast technology.

8. A wireless receiving device comprising:
a communication interface configured to:
receive a first signal for distance estimation by an external electronic device from a wireless transmitting device, and
receive a second signal including a plurality of audio sources and mapping information, the mapping information comprising mapping between a plurality of transmission areas and the plurality of audio sources from the wireless transmitting device; and
an audio source selection and playback circuit configured to: based on the first signal and the second signal, estimate a distance to the wireless transmitting device,
select one of the plurality of audio sources, and
play back the selected audio source.

9. The wireless receiving device of claim 8, wherein the mapping information indicates the plurality of audio sources respectively corresponding to the plurality of transmission areas in which the wireless transmitting device is centered.

10. The wireless receiving device of claim 9, wherein the mapping information comprises mapping of a first transmission area among the plurality of transmission areas to a first audio source among the plurality of audio sources and comprises mapping of a second transmission area among the plurality of transmission areas to a second audio source among the plurality of audio sources.

11. The wireless receiving device of claim 10, wherein a first distance of the first transmission area from the wireless transmitting device is less than a second distance of the second transmission area from the wireless transmitting device, and
wherein a first volume level of the first audio source is greater than a second volume level of the second audio source.

12. The wireless receiving device of claim 9, wherein the plurality of transmission areas are circular.

13. The wireless receiving device of claim 8, wherein the wireless receiving device estimates a distance from the wireless receiving device to the wireless transmitting device based on the first signal.

14. The wireless receiving device of claim 13, wherein the wireless receiving device selects one of the plurality of audio sources based on the mapping information and the estimated distance to the wireless transmitting device.

15. The wireless receiving device of claim 14, wherein the wireless receiving device is configured to:
select a first audio source among the plurality of audio sources based on a first distance estimated to the wireless transmitting device; and
select a second audio source among the plurality of audio sources based on a second distance estimated to the wireless transmitting device.

16. The wireless receiving device of claim 8, wherein the first signal is based on a Bluetooth channel sounding technology, and
wherein the second signal is based on a Bluetooth^{®} LE audio auracast technology.

17. A method of operating a wireless receiving device, the method comprising:
receiving a first signal and a second signal, wherein the first signal is a signal for distance estimation by an external electronic device, the second signal comprises mapping information and a plurality of audio sources, the mapping information comprising mapping between a plurality of transmission areas and the plurality of audio sources;
estimating a distance to a wireless transmitting device based on the first signal;
selecting one of the plurality of audio sources based on the second signal and the estimated distance to the wireless transmitting device; and
playing the selected audio source.

18. The method of claim 17, wherein the mapping information indicates the plurality of audio sources respectively corresponding to the plurality of transmission areas in which the wireless transmitting device is centered.

19. The method of claim 17, wherein the selecting of the one of the plurality of audio sources includes:
selecting a first audio source among the plurality of audio sources based on a first distance estimated to the wireless transmitting device; and
selecting a second audio source among the plurality of audio sources based on a second distance estimated to the wireless transmitting device.

20. The method of claim 17, wherein the first signal is based on a Bluetooth channel sounding technology, and
wherein the second signal is based on a Bluetooth^{®} LE audio auracast technology.
